(19) United States
(12) Patent Application Publication
(10) Pub. No.: US 2007/0070818 A1
(43) Pub. Date: Mar. 29, 2007

(54) Timepiece apparatus

(75) Inventors: Hitoshi Inomata, Kunitachi-shi (JP); Kohki Arita, Fussa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 11/525,587

(22) Filed: Sep. 22, 2006

(30) Foreign Application Priority Data
Sep. 27, 2005 (JP) 2005-279001
Nov. 10, 2005 (JP) 2005-325654

(51) Int. Cl. G04B 47/00

(52) U.S. Cl. 368/10

(57) ABSTRACT

A timepiece apparatus is provided in which a bottom cover is attached to a lower end of a case. The bottom cover supports and positions a timepiece module within the case via a support. A thin magnetic member of a proper size is positioned at the support so as to face toward an antenna built in the timepiece module.

### BACKGROUND OF THE INVENTION

1. Field of the Invention

The present invention relates to a timepiece apparatus and more particularly to an electronic wristwatch with an antenna for receiving radio waves.

2. Background Art

Electronic wristwatches may be radio controlled with an antenna. This type of wristwatch includes a plastic case with a pair of band attachments provided at opposite positions on the outer periphery of the case, with an antenna provided within a space in one of the band attachments so as not to suffer electromagnetic interference from a bottom metal cover of the wristwatch, as disclosed in Published Unexamined Japanese Patent Application 2002-98780 (U.S. Pat. No. 6,657,922).

The arrangement of the antenna external to the case restricts the case in several respects. For example, the outer appearance and design of the wristwatch are impaired. Furthermore, the antenna and the watch module must be assembled separately and connected electrically. Thus, the assembly operation is complicated and troublesome.

It is therefore an object of the present invention to provide a timepiece apparatus which solves such problems and ensures good reception performance for the antenna.

### SUMMARY OF THE INVENTION

In order to achieve the above object, in a timepiece apparatus according to the present invention, a support is positioned within the case of the timepiece apparatus so as to support a watch module that has a built-in antenna. A thin magnetic member is provided at a position on the support such that the magnetic member faces toward the antenna so as to protect the antenna from electromagnetic interference.

The above and other objects, features and advantages of the present invention will become apparent in the following detailed description and modifications thereof when read in conjunction with the accompanying drawings wherein the same reference numerals denote like or similar parts throughout the several views.

### BRIEF DESCRIPTION OF THE DRAWINGS

FIG. 1 is an enlarged cross-sectional view of an electronic wristwatch according to a first embodiment of the present invention;

FIG. 2 is a bottom view of the wristwatch of FIG. 1 with its bottom cover removed;

FIG. 3 is a bottom view of the wristwatch of FIG. 2 with its support removed;

FIG. 4 is a bottom view of a watch module of FIG. 3;

FIG. 5 is an exploded perspective view of the support and associated members of FIG. 2 shown upside down;

FIG. 6 is an exploded perspective view of the support and associated members of FIG. 5 as viewed from the upper right of FIG. 5;

FIGS. 7A, 7B and 7C are a plan view, a side view and a bottom view, respectively, of the support of FIGS. 5 and 6;

FIG. 8 is an enlarged cross-sectional view of a part of the wristwatch where a magnetic member is disposed relative to the support of FIG. 1;

FIG. 9 is an enlarged cross-sectional view of a portion of a first modification;

FIG. 10 is a view similar to FIG. 9 showing a portion of a second modification;

FIG. 11 is a view similar to FIG. 9 showing a portion of a third modification;

FIG. 12 is an enlarged perspective view of a magnetic member of FIG. 11;

FIG. 13 is a view similar to FIG. 9 showing a portion of a fourth modification;

FIG. 14 is a view similar to FIG. 9 showing a portion of a fifth modification;

FIG. 15 is a view similar to FIG. 9 showing a portion of a sixth modification;

FIG. 16 is an enlarged cross-sectional view of an analog electronic wristwatch according to a second embodiment of the present invention;

FIG. 17 is a bottom view of the wristwatch of FIG. 16 with its bottom cover removed;

FIG. 18 is an enlarged cross-sectional view of a portion of the wristwatch taken along line XVIII-XVIII of FIG. 17 turned upside down;

FIG. 19 is an enlarged perspective view of the support of FIG. 16 as viewed obliquely from its upper left side;

FIG. 20 is an enlarged plan view of the support of FIG. 19;

FIG. 21 is a cross-sectional view taken along line XXI-XXI of FIG. 20; and

FIGS. 22A and 22B are an enlarged plan view and an enlarged front view, respectively, of a modification of a position restricting pin of FIG. 16.

### DETAILED DESCRIPTION OF THE INVENTION

[First Embodiment]

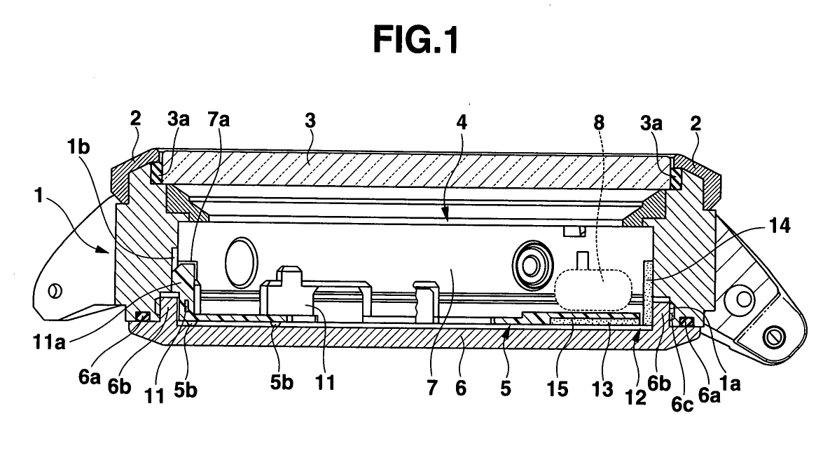

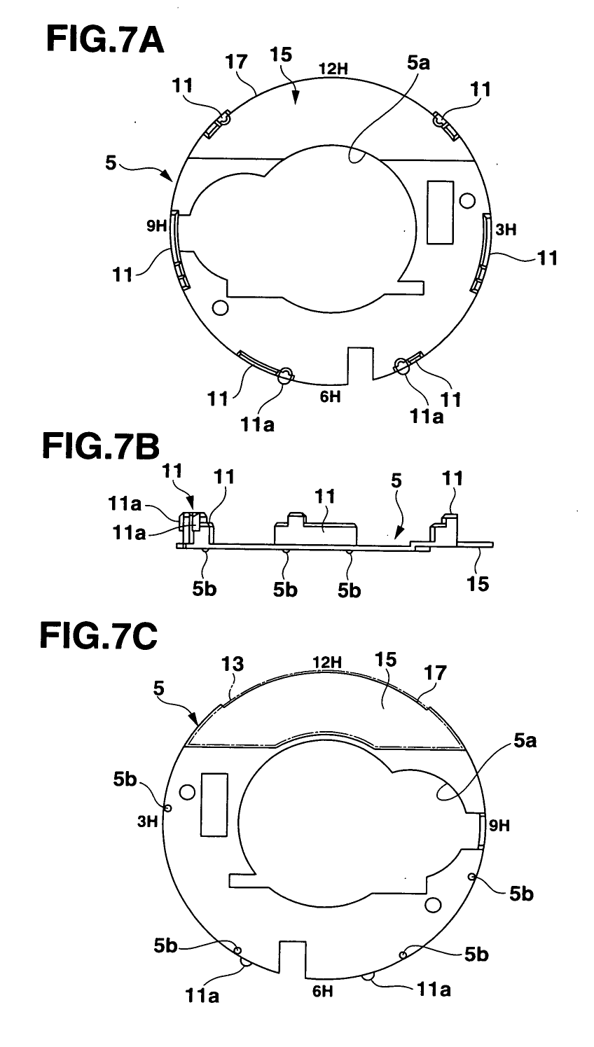

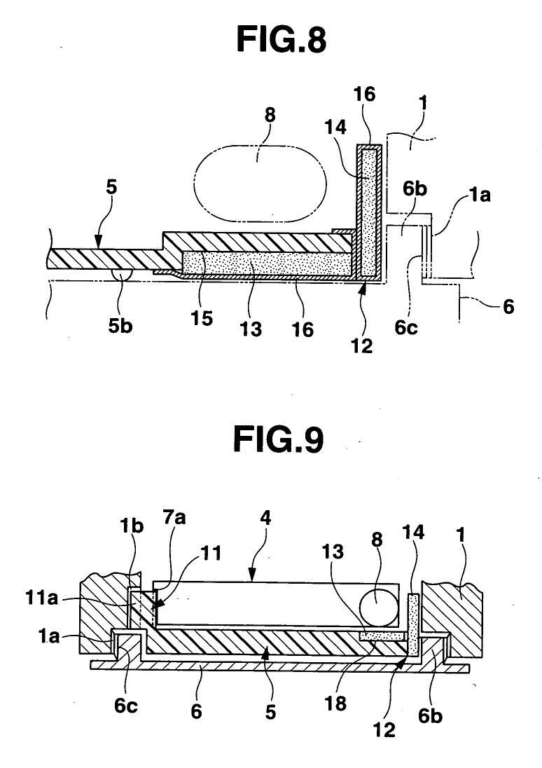

Referring to FIGS. 1-8, a first embodiment of a timepiece apparatus and more particularly a digital electronic wristwatch according to the present invention will be described.

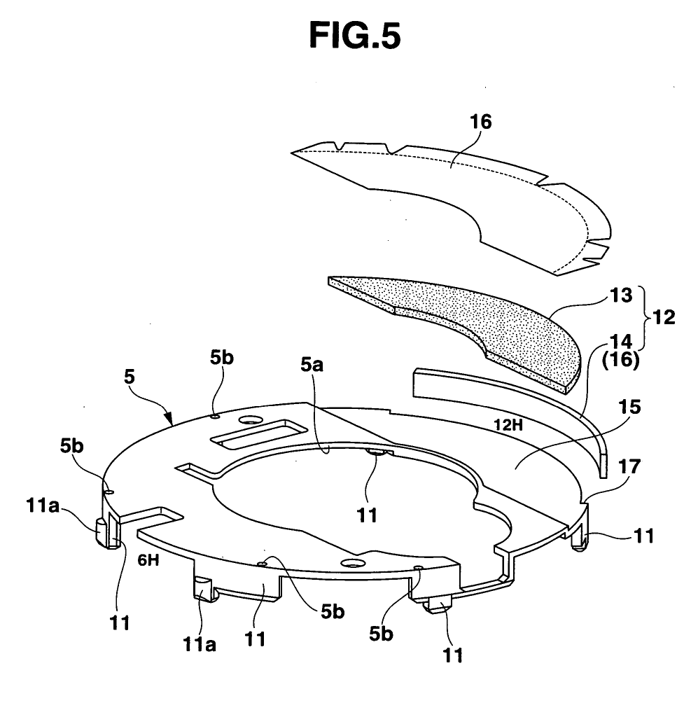

As shown in FIG. 1, the wristwatch of the present invention has a ring-like metal case 1 with a bezel 2 attached over the upper end of the case and with a crystal 3 covering the upper end of the case with a gasket 3a provided around the crystal. As shown in FIGS. 1, 2 and 3, the case 1 receives a disk-like watch module 4 positioned by a disk-like dielectric plastic support 5 (see FIGS. 5-7) having substantially the same extension as the watch module. A bottom metal cover 6 is attached through a waterproof ring 6a to the lower end of the case 1.

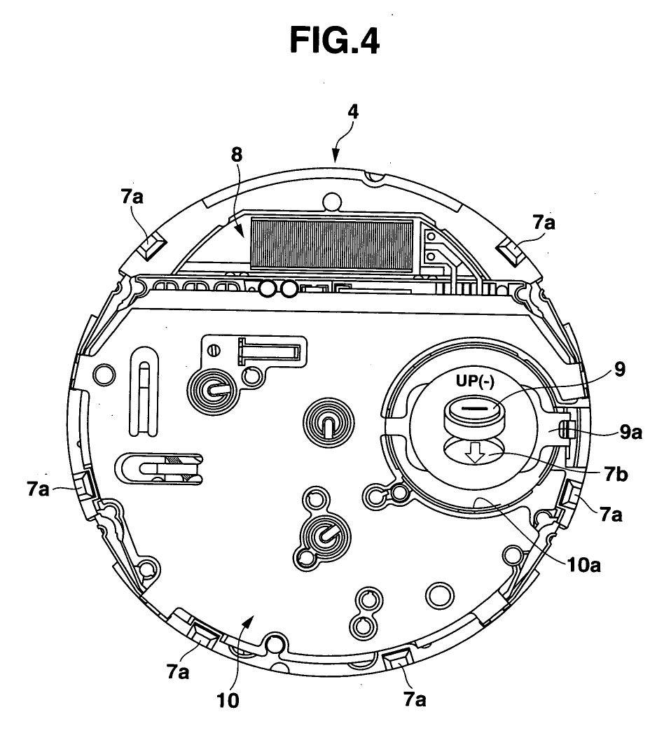

As shown in FIG. 4, the watch module 4 has a dielectric ring-like plastic housing 7 that contains various components such as an analog movement (not shown), an antenna 8, a cell (battery) 29 and a circuit board 10 necessary for performing the timepiece functions. The antenna 8 comprises a cored coil provided in position, or more particularly, at the 12 o'clock position, within the case 1 where radio waves can be received well when the wristwatch is worn around a user's wrist. The antenna 8 is connected electrically to the circuit board 10 and receives a standard time and frequency signal at intervals of a predetermined time.

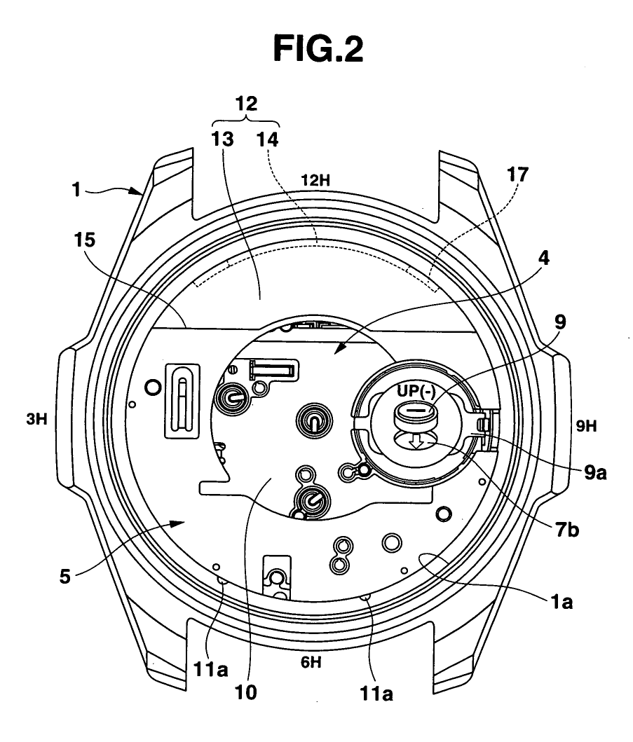

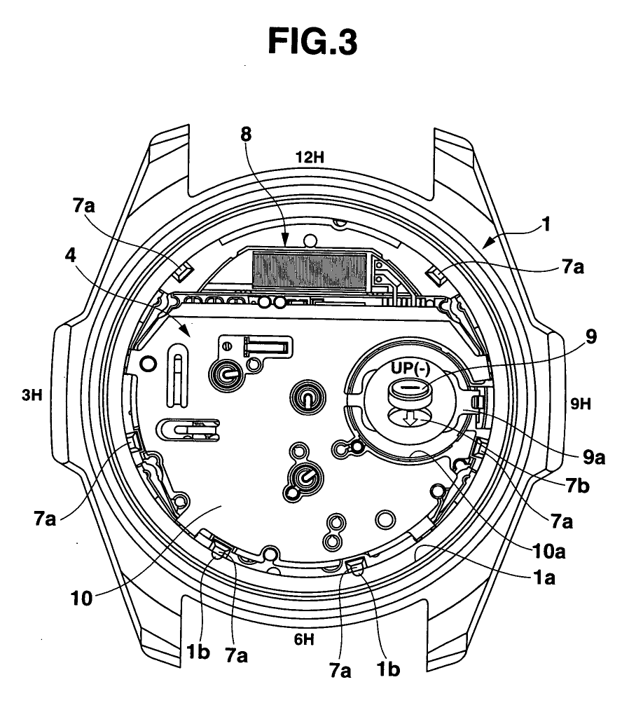

As shown in FIGS. 2-4, the cell 29 is received in a space 7b in the housing 7 at the 9 o'clock position, and is connected electrically with the circuit board 10 through an electrode 9a, thereby supplying power to the whole circuit. As shown in FIGS. 3 and 4, the circuit board 10 has a substantially crescent-shaped opening therein in which the antenna 8 is received and an opening 10a therein through which the cell 29 will be exchanged. As shown in FIG. 1, the bottom cover 6 is attached to the lower end of the case 1 such that an outer-threaded ring 6b of the cover 6 is screwed to an inner-threaded lower end 1a of the case 1.

As shown in FIGS. 5-7C, the disk-like support 5 has an opening 5a for a central part of the watch module 4 and the cell 29, and a plurality of lateral raised portions 5b which are provided at spaced positions along the periphery of a lower end of the disk-like support 5 and come into point contact with the inner surface of the bottom cover 6.

The support 5 is made of a slippery dielectric plastic material such as, for example polyacetal resin, softer than the case 1 and the housing 7, which are made of metal and hard polyetherimide (PEI) resin, respectively.

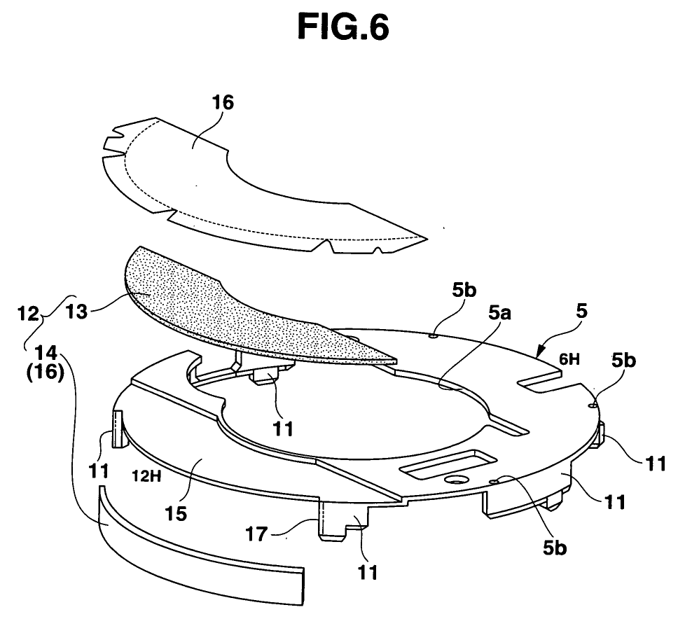

As shown in FIGS. 5-7C, a plurality of upward (in FIG. 5 and 6, downward) position restrictors 11 are provided integrally with the support 5 at the 2, 3, 5, 7, 9 and 10 o'clock positions along the outer periphery of the support 5 so as to fit into a like number of recesses 7a provided on the outer periphery of the housing 7. At least the 5 and 7 o'clock ones of the position restrictors 11 have respective raised portions 11a extending radially outward that fit into corresponding recesses 1b provided on the inner peripheral surface of the case 1.

When the support is disposed below the watch module 4 and the position restrictors 11 of the support 5 fit into the respective recesses 7a provided on the outer periphery of the housing 7 with the watch module 4 received within the case 1, the support 5 is in position relative to the watch module 4. When the raised portions 11a of the position restrictors 11 fit into the respective recesses 1b provided along the inner peripheral surface of the case 1, the support 5 is in position relative to the case 1. This prevents rotating and shaking of the watch module 4 within the case 1, and positions the watch module 4 within the case 1.

A thin magnetic member 12 as shown in FIGS. 1, 5 and 6 is provided near to the antenna 8 of the watch module 4. As shown in FIGS. 1, 5, 6 and 8, the magnetic member 12 comprises a first thin flat crescent-shaped magnetic member part 13 received in a recess 15 provided in the lower surface (in FIGS. 5 and 6, upper surface) of the support 5 at a position corresponding to the antenna 8 and a second upright thin arcuate magnetic member part 14 provided beside the antenna 8 in a recess 17 provided along the outer periphery of the support 5. The first and second magnetic member parts 13 and 14 are for preventing electromagnetic interference from the metal bottom cover 6 and the metal case 1, and are each made of a complex magnetic mixture of resin and magnetic powder having a grain size on the order of microns. Each of the first and second magnetic member parts 13 and 14 is covered with a protective film 16.

The first and second magnetic member parts 13 and 14 allow the magnetic flux of a magnetic field generated by the antenna 8 to enter the respective surfaces thereof, thereby producing eddy currents and inducing magnetic flux only on the respective surfaces thereof, thereby preventing the magnetic flux from passing through the magnetic member parts 13 and 14. Thus, the magnetic flux produced by the antenna 8 is protected from electromagnetic interference caused by the metal bottom cover 6 and the metal case 1.

When the wristwatch is assembled, the watch module 4 is supported by the bottom cover 6 via the support 5 and positioned within the case 1. At this time, the plurality of position restrictors 11 provided along the outer periphery of the support 5 are fitted into the corresponding recesses 7a provided along the outer periphery of the housing 7 with the raised portions 11a of the position restrictors 11 fitting into the corresponding recesses 1b provided along the inner periphery of the case 1. This prevents rotation and shaking of the watch module 4 within the case 1 and positions the watch module 4 surely in position within the case 1.

In this wristwatch, the magnetic member 12 comprises the first magnetic member part 13 disposed below the antenna 8 and the second magnetic member part 14 disposed beside the antenna 8. Thus, the magnetic member 12 protects the antenna 8 from electromagnetic interference caused by the metal bottom cover 6 and the metal case 1. This ensures the antenna 8 good reception performance even though the antenna is disposed within the watch module 4 which in turn is disposed within the case 1.

Thus, the case 1 is not restricted by the antenna 8. That is, the outer appearance and design of the wristwatch are not impaired. In addition, the antenna 8 and the watch module 4 need not be assembled separately into the case 1. Both the antenna 8 and the watch module 4 can be assembled into the case 1 in a state in which both are connected electrically, so that the assembly operation is simplified and the productivity is improved.

The support 5 has the recess 15 that positions the first magnetic member part 13 and the recess 17 that positions the second magnetic member part 14. Thus, the first magnetic member part 13 is positioned at the predetermined position, or in the recess 15 in the support 5 below the antenna 8. In addition, the second magnetic member part 14 is positioned beside the antenna 8 within the recess 17 provided at the predetermined position on the support 5. Therefore, when the bottom cover 6 is attached to the lower end of the case 1, the bottom cover 6 positions the first and second magnetic member parts 13 and 14 accurately relative to the antenna 8 without deviation.

The bottom cover 6 is attached to the case 1 such that the outer -threaded ring 6b of the bottom cover 6 is screwed to the lower inner-threaded peripheral surface 1a of the case 1. In this case, the first magnetic member part 13 is positioned in the recess 15 relative to the support 5 and the second magnetic member part 14 is positioned in the recess 17 relative to the support 5. Thus, even when the bottom cover 6 is attached by rotation to the case 1, the first and second magnetic member parts 13 and 14 are positioned accurately and securely relative to the antenna 8 without deviation.

[First Modification]

While in the first embodiment the recess 15 that positions the first magnetic member part 13 is illustrated as provided on the lower surface (in FIGS. 5 and 6, upper surface) of the support 5, the recess may be provided on the upper surface of the support 5, as shown by 18 in FIG. 9. In this structure, since the first magnetic member part 13 does not come into contact with the bottom cover 6, the first magnetic member part 13 is disposed more exactly in position below the antenna 8.

[Second Modification]

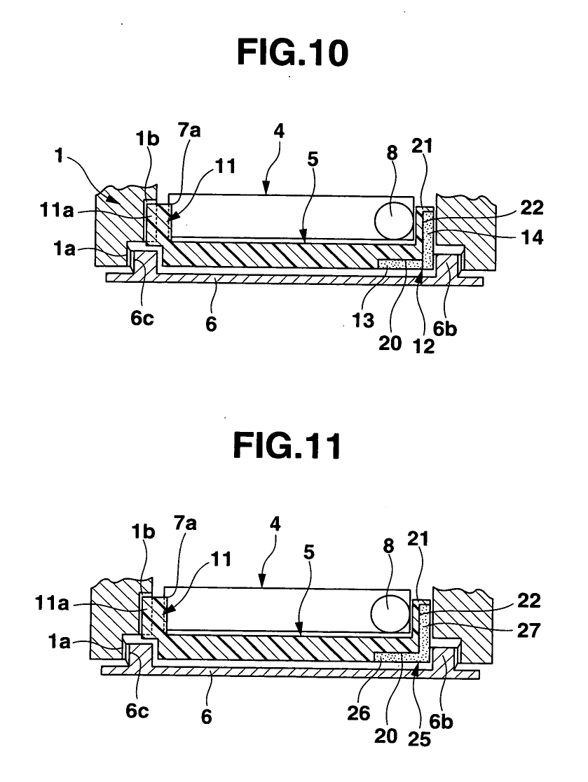

Then, referring to FIG. 10, a second modification of the electronic wristwatch will be described. As shown in FIG. 10, in this modification, a first thin magnetic member part 13 having an extension enough to cover the antenna 8 is provided in a first recess 20 formed in a part of the lower surface of the support 5 corresponding in position to the antenna 8. The support 5 has an upright side wall portion 21 extending so as to partially surround the antenna 8 with a second thin magnetic member part 14 received in a second peripheral recess 22 provided on the outer peripheral surface of the side wall portion 21 so as to be continuous to the first recess 20. This modification is substantially the same in other respects as the first embodiment.

This modification produces beneficial effects similar to those produced by the first embodiment. Furthermore, since the first and second magnetic member parts 13 and 14 are positioned in the first and second recesses 20 and 22, respectively, in the support 5, they are securely fixed to the support 5. Thus, when the bottom cover 6 is attached to the lower end of the case 1, the first and second magnetic member parts 13 and 14 are positioned further accurately and securely relative to the antenna 8 without being influenced by the bottom cover 6 compared to the first embodiment.

[Third Modification]

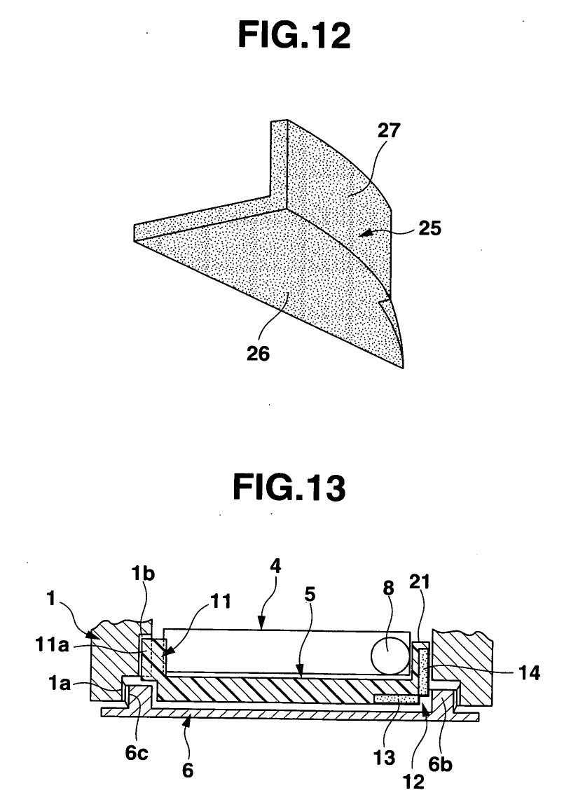

Referring to FIGS. 11 and 12, a third modification of the electronic wristwatch will be described. The feature of this modification is that first and second thin magnetic member parts 26 and 27 are formed integrally by bending a single thin magnetic member 25. This modification is substantially the same in other respects as the second modification.

As shown in FIG. 11, like the second modification of FIG. 10 the first magnetic member part 26 is received in the first recess 20 formed in the lower surface of the support 5 corresponding in position to the antenna 8. The second magnetic member part 27 is received in the second recess 22, which is continuous to the first recess 20, provided on the outer periphery of the side wall portion 21 of the support 5 beside the antenna 8, like the second modification of FIG. 10.

This wristwatch produces beneficial effects similar to those produced by the first embodiment and second modification. The first and second magnetic member parts 26 and 27 are formed integrally by bending the single magnetic member. Thus, there is no gap between the first and second magnetic member parts 26 and 27, thereby preventing electromagnetic interference caused by the metal bottom cover 6 and the metal case 1 and hence improving the reception performance of the antenna 8. Since the magnetic member part 25 is a single piece and the number of parts of the wristwatch does not increase, the assembly operation is simplified and productivity is improved.

[Fourth Modification]

Referring to FIG. 13, a fourth modification of the wristwatch will be described. This modification has substantially the same structure as the first embodiment and second modification with the exception that the support 5 is formed integrally with the first and second magnetic member parts 13 and 14 of the magnetic member 12 by insert molding.

Thus, the first and second magnetic member parts 13 and 14 are fixed in position securely relative to the antenna 8. Since the magnetic member 12 is not a separate part from the support 5, the number of parts of this wristwatch does not increase. The support 5 and the magnetic member 12 are assembled simultaneously, thereby improving the assembly efficiency.

While in this modification the two separate first and second magnetic member parts 13 and 14 are illustrated, the first and second magnetic member parts 26 and 27 obtained as a unit by bending a single magnetic member 25 may be molded integrally with the support 5. This fabrication is easily achieved.

[Fifth Modification]

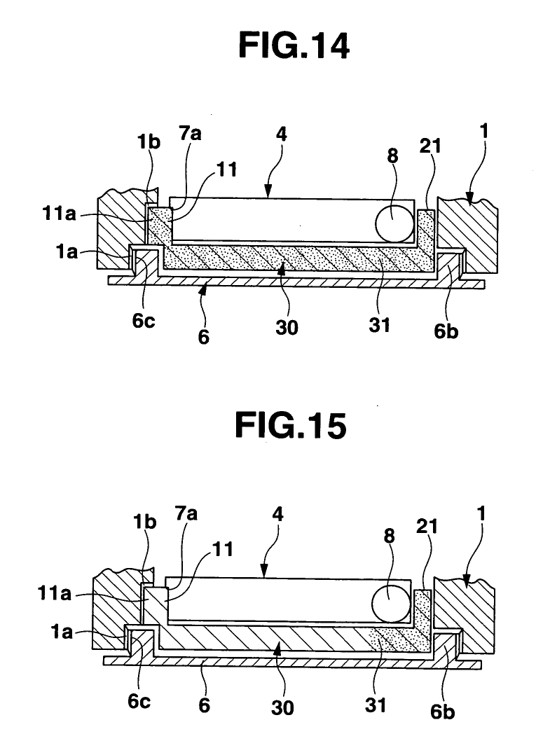

Referring to FIG. 14, a fifth modification of the wristwatch will be described. As shown in FIG. 14, this modification has substantially the same structure as the first embodiment with the exception that the support 30 is formed by injection molding with a mixture of resin and magnetic powder 31. The support 30 has a plurality of position restrictors 11 and a side wall 21 beside the antenna 8.

According to this wristwatch, as in the first embodiment the watch module 4 is supported and positioned within the case 1 by the support 30. The support 30 that contains the dispersed magnetic powder 31 protects the antenna 8 arranged within the watch module 4 from electromagnetic interference caused by the metal bottom cover 6 and the metal case 1. Hence good reception performance of the antenna 8 is maintained. Unlike the first embodiment and the above-mentioned modifications, this modification does not require magnetic members or member parts, thereby reducing the number of parts of the wristwatch, facilitating assembly of the wristwatch, and hence improving productivity.

[Sixth Modification]

While in the fifth modification the magnetic powder 31 is illustrated as dispersed throughout the whole support 30, in a sixth modification the magnetic powder 31 may be dispersed only in that part of the support member 30 that covers the extension of the antenna 8, as shown in FIG. 15. In this case, two different parts of the support 30 (one that contains the magnetic powder 31 and one that does not contain the magnetic powder) may be molded as a unit by coinjection molding. By doing so, as according to the fifth modification a resulting wristwatch ensures good reception performance for the antenna 8, and the sixth modification also minimizes the influence of the magnetic powder 31 on the watch module 4.

While in the first embodiment and modifications wristwatches are illustrated in which the bottom cover 6 is attached to the case 1 in such a manner that the outer-threaded ring 6b of the bottom cover 6 is screwed by rotating the bottom cover 6 with respect to the inner threaded peripheral surface 1a of the case 1, the bottom cover may be attached directly by screws to the lower end of the case 1.

[Second Embodiment]

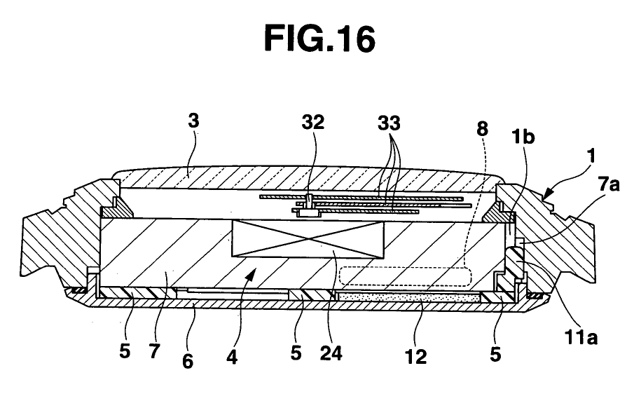

Referring to FIGS. 16-21, an analog or hand type wristwatch according to a second embodiment of the invention will be described.

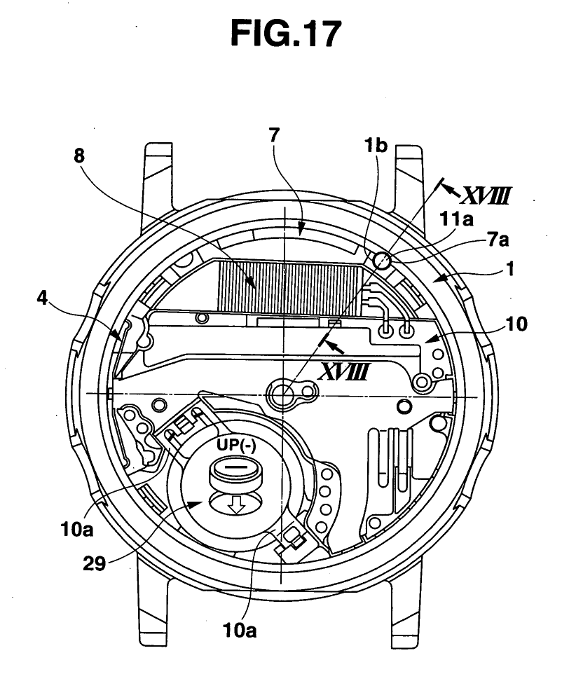

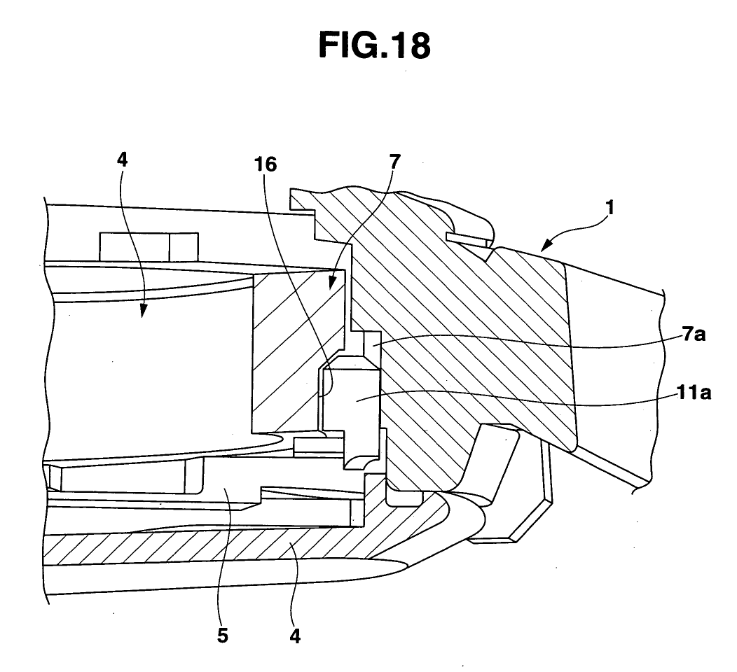

As shown in FIGS. 16 and 17, the wristwatch according to the second embodiment has a ring-like metal case 1 over which a crystal 3 is attached. A disk-like watch module 4 is supported and housed by a disk- or ring-like dielectric support 5 within the case 1. A metal bottom cover 6 covers the lower end of the case 1, as shown in FIGS. 16 and 18.

The module 4 has a ring-like plastic housing 7 that contains components such as an analog movement 24 (see FIG. 16), an antenna 8, a cell (battery) 20 and a circuit board 10 (see FIG. 17) necessary for performing the timepiece functions.

In the analog movement 24 (see in FIG. 16) a step motor (not shown) rotates to drive a gear train mechanism (not shown) which causes hour, minute and second hand axles 32 to rotate and hence causes the hour, minute and second hands 33 attached to the axles 32 to sweep over a dial plate (not shown) to indicate time. When the wristwatch is worn on a user's wrist, the antenna 8 is disposed at a position within the case 1 where radio waves are easily received, or at the at 12 o'clock position within the housing 7. The antenna 8 is connected electrically to the circuit board 10 so as to receive a standard time and frequency signal at intervals of a predetermined time to control the operation of the movement 24 and set the time automatically.

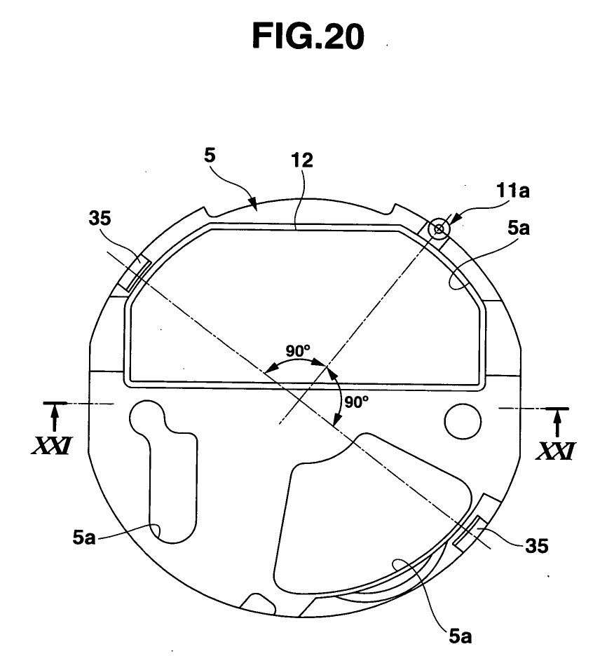

As shown in FIG. 16, a thin magnetic member 12 made of magnetic powder covered with a protective film (not shown) is provided on the inner surface of the bottom cover 6 and is fitted in an opening 5a formed in the disc-like dielectric plastic support 5 (see FIG. 20), which is provided between the watch module 4 and the metal bottom cover 6 so as to face toward the antenna 8. The magnetic member 12 has the same extension as the antenna 8. Thus, the antenna 8 and hence the magnetic flux produced by the antenna 8 are protected from electromagnetic interference caused by the metal bottom cover 6 for the same reason as mentioned in the first embodiment.

As shown in FIG. 17, the cell 20 is disposed in the housing 7 between the 3 and 6 o'clock positions and is connected electrically through an electrode 10a to the circuit board 10 to supply power.

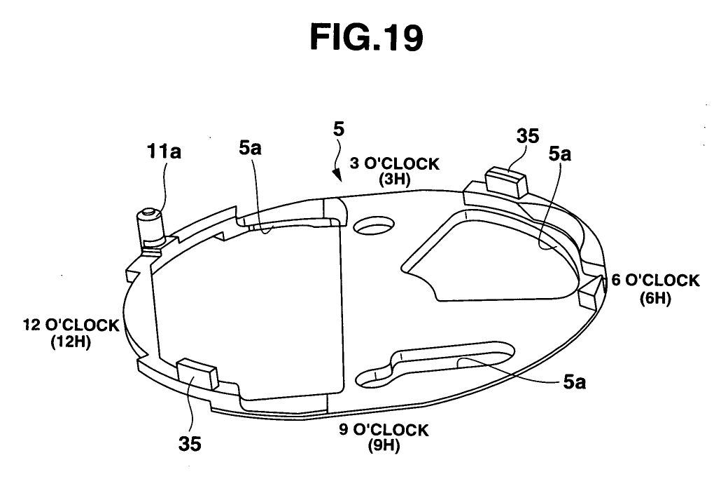

As shown in FIGS. 16 and 18, the support 5 is disposed below the watch module 4 and is supported by the bottom cover 6, thereby fixing the watch module 4 in the case 1. As shown in FIGS. 19 and 20, the support 5 takes the form of a disk or ring having substantially the same extension as the lower end of the watch module 4. In addition to the opening 5a where the magnetic member 12 is fitted, the support 5 has openings 5b and 5c through which the cell 20 and leads (not shown) will be exchanged and passed, respectively.

As shown in of FIGS. 19-21, the support 5 has an upright position restricting pin 11a provided at substantially the 1 o'clock position on the outer periphery of the upper surface thereof and a pair of upright tooth-shaped shake preventing protrusions 35 provided at positions spaced by 90 degrees clockwise and counterclockwise from the position of the restricting pin 11a along the outer periphery of the upper surface of the support 5.

In order to receive the position restricting pin 11a, a circular cross-sectional cavity is formed at the same position as the restricting pin 11a between the inner surface of the case 1 and the outer surface of the housing 7. The cavity is composed of a pair of (first and second) cooperative semi-circular cross-sectional recesses 7a and 16 provided in the inner and outer surfaces of the case 1 and the housing 7, respectively, at the same position as the restricting pin 11a, as shown in FIGS. 16-18. In addition, in order to receive the pair of protrusions 35, a pair of cavities (not shown) are provided at the same positions as the pair of protrusions 35 between the inner surface of the case 1 and the outer surface of the housing 7. Each cavity for receiving one of the protrusion 35 is formed of a pair of cooperative subcavities (not shown) provided on the inner and outer peripheral surfaces of the case 1 and the housing 7, respectively.

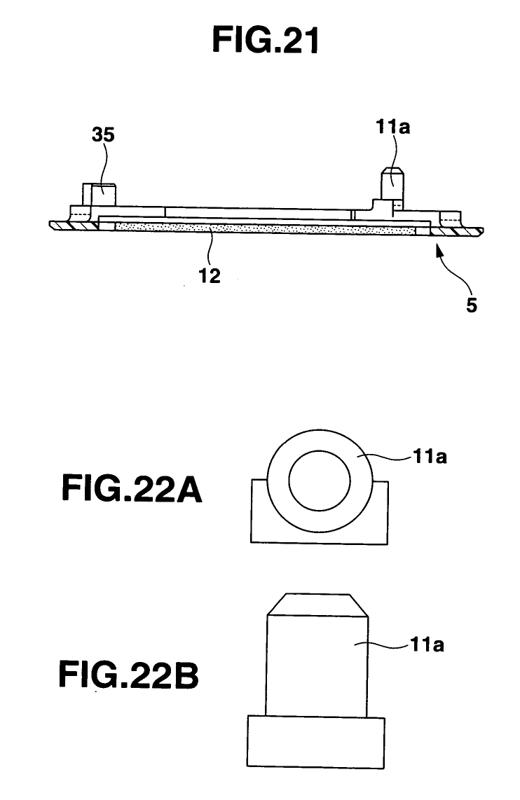

As mentioned above, the case 1 is made of metal and the housing 7 is made of hard polyetherimide (PEI) resin. The position restricting pin 11a is made of polyacetal resin that is slippery and softer than the case 1 and the housing 7. The support 5 is preferably made of the same material as the position restricting pin 11a so as to be integral with the position restricting pin 11a, but they may be integrally made of different materials by coinjection molding. The pair of shake preventing protrusions 35 of FIGS. 20 and 21 are made integral with the support 5 and of the same material as the support 5.

When the wristwatch is assembled, the support 5 disposed below the watch module 4 is supported by the bottom cover 6 in a state in which the first and second positioning recesses 7a and 16 provided on the inner and outer peripheral surfaces of the case 1 and the housing 7, respectively, cooperate to form the cavity, and then the position restriction pin 11a is inserted into the cavity. This positions the watch module 4 within the case 1, and prevents the watch module 4 from rotating within the case 1. In this case, the pair of shake preventing protrusions 35 are also inserted into the pair of cavities formed between the inner and outer peripheral surfaces of the case 1 and the housing 7, so as to prevent the watch module 4 from shaking within the case 1, thereby fixing the watch module 4 at exactly the predetermined position for the watch module 4 within the case 1 at all times.

Thus, no inner positioning frame, as is used in the prior art, is required to position the watch module 4 within the case 1. Consequently, the watch module 4 is reduced approximately by 1 mm in size and hence the case and the whole wristwatch are reduced in size.

As described above, the support 5 has the position restricting pin 11a and the pair of shake preventing protrusions 35. Thus, not only does the single position restricting pin 11a position the watch module 4 so as not to rotate within the case 1, but also the pair of shake-preventing protrusions 35 prevents the watch module 4 from shaking around the position restricting pin 11a within the case 1. Thus, the watch module 4 is fixed at all times at the predetermined position thereof within the case 1.

As described above, the support 5 takes substantially the form of a disc covering the lower end of the watch module 4. Thus, the support 5 positions the watch module 4 securely and well in a stabilized manner within the case 1. In addition, since the support 5 has the position restricting pin 11a and the pair of shake preventing protrusions 35 formed integrally therewith at predetermined positions on the outer periphery thereof, the number of parts of the wristwatch does not increase. When the support 5 is assembled, the position restricting pin 11a and the pair of shake preventing protrusions 35 are assembled simultaneously, thereby simplifying the assembly operation.

In assembling the wristwatch, since the position restricting pin 11a is made of the slippery plastic material including, for example polyacetal resin, which is softer than the case 1 and the housing 7, the position restricting pin 11a can be smoothly and securely inserted into the cavity formed by the first and second cooperative positioning recesses 7a and 16 provided on the inner and outer peripheral surfaces of the case 1 and the housing 7, respectively. This causes the watch module 4 to be positioned accurately at a predetermined position within the case 1. Since the position restricting pin 11a has a pointed end, it can be inserted easily and smoothly into the cavity formed by the first and second positioning recesses 7a and 16, thereby improving the assembly efficiency.

As described above, in the wristwatch of this embodiment the watch module 4 including the built-in antenna 8 is positioned within the case 1 by the position restricting pin 11a and the pair of shake preventing protrusions 35 of the support 5. Thus, the antenna 8 is disposed at the predetermined position, or at the 12 o'clock position, within the case 1 where electromagnetic interference of the reception performance of the antenna 8 is inhibited.

Consequently, the antenna 8 can receive a standard time and frequency signal at intervals of a predetermined time, thereby allowing the time to be set automatically, and hence giving an accurate time indication at all times. Hence the reception performance of the antenna 8 is improved, thereby allowing the standard time and frequency signal to be received well. Unless the watch module 4 is positioned in position within the case 1, accurate time indication could not be given.

As described above, the support 5 causes the thin magnetic member 12 provided on the inner surface of the bottom cover 6 to be positioned in the opening 5a provided therein below the antenna 8. Thus, although the metal bottom cover 6 is disposed below the support 5, the antenna 8 can receive the standard time and frequency signal well without being influenced adversely by the bottom cover 6. Thus, the metal bottom cover 6 is disposed closer to the antenna 8 than otherwise possible. This renders the whole watch module compact and the whole watch small in size.

While in this embodiment the position restricting pin 11a is illustrated as being provided integrally with the support 5, it may be formed separately from the support, for example, as shown by reference numeral 11a in FIGS. 22A and 22B. In this case, before the support 5 is assembled, the position restricting pin 11a is required to be inserted into the cavity composed of the first and second positioning recesses 7a and 16, thereby positioning the watch module 4 within the case 1.

While in this embodiment the single position restricting pin 11a is illustrated as provided at the specified position on the support 5, a plurality of (preferably 3) position restricting pins 11a may be provided along the periphery of the support 5. In this case, no shake preventing protrusions such as 35 are required to be provided on the support 5. The plurality of position restricting pins 11a serve to position the watch module 4 within the case 1 and prevent the watch module 4 from shaking laterally.

While in the first embodiment, its modifications, and the second embodiment the present invention is illustrated as being applied to the electronic digital and analog wristwatches, the present invention also is applicable widely to other electronic timepieces such as pocket watches, travel watches, alarm clocks, clocks and wall clocks.

[Summary of the Embodiments and Modifications]

As shown in FIGS. 1-13, a timepiece apparatus according to one aspect of the present invention includes: a timepiece module (4) including a built-in antenna (8); a case (1) which houses the timepiece module and which has a lower end closed with a bottom cover (6); a support (5), which is disposed between the timepiece module and the bottom cover so as to be supported by the bottom cover, and which positions the timepiece module within the case; and a thin magnetic member (12, 25) facing toward the antenna within the timepiece module.

Thus, according to this arrangement, the wristwatch module is supported and positioned within the case by the bottom cover via the support disposed below the watch module, and the bottom cover is attached to the lower end of the case. The thin magnetic member is disposed so as to face toward the antenna within the timepiece module. Thus, the magnetic member protects the antenna from electromagnetic interference caused by the bottom cover and the case even when the bottom cover and the case are made of metal. This ensures good reception performance for the antenna.

As shown in FIGS. 1-13, the thin magnetic member (12, 25) includes a first magnetic member part (13, 26) disposed below the antenna (8) and a second magnetic member part (14, 27) disposed beside the antenna, and the first and second magnetic member parts face toward the antenna.

Thus, according to this arrangement, the magnetic member protects the antenna from electromagnetic interference caused by the bottom cover and the case even when the bottom cover and the case are made of metal, thereby ensuring good reception performance for the antenna.

As shown in FIGS. 11 and 12, each of the first and second magnetic member parts (26, 27) is part of a same single magnetic member (25), which is bent to form the first and second magnetic member parts.

Thus, according to this arrangement, there is no gap between the first and second magnetic member parts. Thus, electromagnetic interference on the antenna from the metal bottom cover and case is prevented more securely. This further improves radio-wave reception performance of the antenna. Furthermore, since the first and second magnetic member parts are formed integrally, the number of magnetic members of the timepiece apparatus does not increase. This simplifies the assembly operation of the timepiece apparatus, thereby improving productivity.

As shown in FIGS. 1-9, the support (5) includes first and second position restrictors (15, 18; 16) for positioning the first and second magnetic member parts (13, 14), respectively.

Thus, according to this arrangement, even when the bottom cover is attached to the case directly or by screwed connection, the first and second magnetic member parts are positioned accurately and securely relative to the antenna without deviation.

As shown in FIGS. 10-12, the support (5) has first and second recesses (20, 22) therein for receiving and positioning the first and second magnetic member parts (13, 26; 14, 27), respectively.

Thus, according to this arrangement, when the bottom cover is attached to the case the first and second magnetic member parts are positioned accurately and securely relative to the antenna and the support without being influenced adversely by the bottom cover.

As shown in FIG. 13, the magnetic member (12, 25) is integral with the support (5) and is formed by insert molding.

Thus, according to this arrangement, the first and second magnetic member parts are positioned accurately and securely relative to the antenna. In addition, since the magnetic member is not a separate part from the support, the number of parts of the timepiece does not increase. Furthermore, since the support is simultaneously assembled together with the magnetic member parts, the assembly efficiency is improved.

As shown in FIGS. 14 and 15, a timepiece apparatus according to another aspect of the present invention includes: a timepiece module (4) including a built-in antenna (8); a case (1) which houses the timepiece module and which has a lower end closed with a bottom cover (6); and a support (30), which is disposed between the timepiece module and the bottom cover so as to be supported by the bottom cover, and which positions the time piece module within the case; wherein the support (30) contains magnetic powder (31) dispersed therein.

Thus, according to this arrangement, when the time piece module is positioned within the case, the support positions the time piece module within the case. In addition, the support which contains magnetic powder protects the antenna from electromagnetic interference caused by the metal bottom cover and the metal case, thereby ensuring high reception performance for the antenna, even though the antenna is housed along with the timepiece module within the case.

As shown in FIG. 15, the magnetic powder (31) may be dispersed only in a part of the support (30) substantially corresponding to the antenna (8).

Thus, according to this arrangement, good reception performance is ensured for the antenna even though the antenna is disposed in the timepiece module which is housed within the case. In addition, an adverse influence of the magnetic powder on the timepiece module is minimized with this structure.

As shown in FIGS. 16-22B, a timepiece apparatus according to another aspect of the present invention includes: a case (1) having at least one first positioning recess (7a) provided on an inner peripheral surface thereof; a timepiece module (4) with a housing (7) that is positioned within the case, the housing having at least one second positioning recess (16) provided on an outer peripheral surface thereof in a position opposite to the at least one first positioning recess, such that the at least one first positioning recess and cooperates with the at least one second positioning recess opposite thereto to define a cavity; a support (5) positioned at a bottom the timepiece module which supports the timepiece module in the case; and a position restrictor (11a, 11a) inserted into the cavity formed by the opposite first and second positioning recesses, for positioning the timepiece module relative to the case.

According to this arrangement, when the wristwatch is assembled, the support disposed below the timepiece module is supported by the bottom cover in a state in which where at least one pair of the first and second positioning recesses on the inner and outer peripheral surfaces of the case and the housing, respectively, cooperate to form the cavity, and then the position restrictor is inserted into the cavity, thereby positioning the watch module in the case without using an inner frame as is used in a conventional timepiece apparatus.

This prevents the watch module from rotating within the case, thereby ensuring that the watch module is positioned properly within the case. Since the timepiece apparatus uses no inner frame, the timepiece module, the case and hence the whole timepiece apparatus are reduced in size.

Alternatively, for example, a plurality of (preferably 3) position restrictors may be inserted into a like number of cavities, each formed of a respective one of a like number of pairs of cooperative (first and second) positioning recesses, provided along the inner and outer peripheral surfaces of the case and housing, respectively. This securely prevents the timepiece module from rotating and shaking within the case, thereby positioning the watch module accurately and securely within the case.

In FIGS. 16-21, the support (5) is substantially shaped as a disc and overlaps with the bottom of the timepiece module (4), and the position restrictor (11a) is integral with the support.

According to this arrangement, the support takes substantially the form of a disc having substantially the same expansion as the lower end of the watch module. Thus, the timepiece module is positioned securely and well by the support in a stabilized manner within the case. In addition, although the support has the position restrictor integral therewith at a predetermined position thereon, the number of parts of the timepiece apparatus does not increase. When the support is assembled, the position restrictor also is assembled simultaneously, thereby simplifying the assembly operation.

In FIGS. 16-22B, the position restrictor (11a, 11a) is made of a slippery material that is softer than the case (1) and the housing (7) of the timepiece module (4).

Thus, according to this arrangement, the position restrictor is smoothly and securely inserted into the cavity formed by the first and second cooperative positioning recesses in the case and the housing, respectively. This causes the timepiece module to be positioned accurately at the predetermined position within the case, thereby improving the assembly efficiency.

In FIGS. 16-21, the support (5) includes at least one shake preventing piece (35) for preventing the timepiece module (4) from shaking relative to the case (1).

Thus, according to this arrangement, the timepiece module is positioned so as not to shake within the case. Furthermore, the shake preventing piece prevents the timepiece module from shaking sideways relative to the position restrictor within the case. Accordingly, the timepiece module is fixed at an accurate position at all times within the case.

In FIGS. 16-22B, the timepiece module (4) includes an antenna (8).

According to this arrangement, since the timepiece module contains the antenna and is positioned in position within the case by the position restrictor, the timepiece apparatus is capable of receiving a standard time and frequency signal, thereby setting the time and indicating an accurate time at all times.

In FIGS. 16-22B, the antenna (8) is provided at a predetermined position within the timepiece module (4).

According to this arrangement, since the antenna is provided in position within the timepiece module, which in turn is positioned in place by the position restrictors within the case, the antenna is positioned accurately at a predetermined position within the case. Thus, the reception performance of the antenna is not adversely influenced by electromagnetic interference, but improved, and the standard time and frequency signal can be received well.

In FIGS. 16-22B, the timepiece apparatus includes a thin magnetic member (12) positioned in an opening (5a) provided at a position in the support (5) so as to face toward the antenna (8).

Thus, according to this arrangement, although the metal bottom cover is disposed below the support, the antenna can receive the standard time and frequency signal well without being adversely influenced by the bottom cover. Thus, the metal bottom cover can disposed close to the antenna. This renders the whole timepiece module and the whole timepiece apparatus small in size.

The present invention has been described with reference to several exemplary embodiments and modifications. However, it will be readily apparent to those skilled in the art that it is possible to embody the invention in specific forms other than those of the exemplary embodiments and modifications described above. This may be done without departing from the spirit of the invention. These exemplary embodiments and modifications are merely illustrative and should not be considered restrictive in any way. The scope of the invention is given by the appended claims, rather than the preceding description, and all variations and equivalents which fall within the range of the claims are intended to be embraced therein.

This application is based on Japanese Patent Applications Nos. 2005-325654 and 2005-279001 filed on Nov. 10, 2005 and Sep. 27, 2005, respectively, and each including specification, claims, drawings and summaries. The disclosures of the above Japanese patent applications are incorporated herein by reference in their entireties.

What is claimed is:

1. A timepiece apparatus comprising:
a timepiece module including a built-in antenna;
a case which houses the timepiece module, and which has a lower end closed with a bottom cover;
a support which is disposed between the timepiece module and the bottom cover so as to be supported by the bottom cover, and which positions the timepiece module within the case; and
a thin magnetic member positioned by the support so as to face toward the antenna of the timepiece module.

2. The timepiece apparatus of claim 1, wherein the thin magnetic member comprises a first magnetic member part disposed below the antenna and a second magnetic member part disposed beside the antenna, and the first and second magnetic member parts face toward the antenna.

3. The timepiece apparatus of claim 2, wherein each of the first and second magnetic member parts is part of a same single magnetic member, which is bent to form the first and second magnetic member parts.

4. The timepiece apparatus of claim 2, wherein the support comprises first and second position restrictors for positioning the first and second magnetic member parts, respectively.

5. The timepiece apparatus of claim 2, wherein the support comprises first and second recesses for receiving and positioning the first and second magnetic member parts, respectively.

6. The timepiece apparatus of claim 1, wherein the magnetic member is integral with the support and is formed by insert molding.

7. A timepiece apparatus comprising:
a timepiece module including a built-in antenna;
a case which houses the timepiece module, and which has a lower end closed with a bottom cover; and
a support which is disposed between the timepiece module and the bottom cover so as to be supported by the bottom cover, and which positions the time piece module within the case;
wherein the support contains magnetic powder dispersed therein.

8. The timepiece apparatus of claim 7, wherein the magnetic powder is dispersed only in a part of the support substantially corresponding to the antenna.

9. A timepiece apparatus comprising:
a case having at least one first positioning recess provided on an inner peripheral surface thereof;
a timepiece module having a housing and that is positioned within the case, said housing having at least one second positioning recess provided on an outer peripheral surface thereof in a position opposite to the at least one first positioning recess, such that the at least one first positioning recess cooperates with the at least one second positioning recess opposite thereto to define a cavity;
a support positioned at a bottom of the timepiece module, and which supports the timepiece module in the case; and
a position restrictor inserted into the cavity formed by the opposite first and second positioning recesses, for positioning the timepiece module relative to the case.

10. The timepiece apparatus of claim 9, wherein the support is substantially shaped as a disc and overlaps with the bottom of the timepiece module, and the position restrictor is integral with the support.

11. The timepiece apparatus of claim 9, wherein the position restrictor is made of a slippery material that is softer than the case and the housing of the timepiece module.

12. The timepiece apparatus of claim 9, wherein the support further comprises at least one shake preventing piece for preventing the timepiece module from shaking relative to the case.

13. The timepiece apparatus of claim 9, wherein the timepiece module comprises an antenna.

14. The timepiece apparatus of claim 9, wherein the antenna is provided at a predetermined position within the timepiece module.

15. The timepiece apparatus of claim 9, further comprising:
a thin magnetic member positioned in an opening in the support so as to face toward the antenna.
